(19) United States
(12) Patent Application Publication
(10) Pub. No.: US 2016/0014298 A1
(43) Pub. Date: Jan. 14, 2016

(54) IMAGE FORMING APPARATUS, INFORMATION PROCESSING METHOD AND STORAGE MEDIUM

(71) Applicant: CANON KABUSHIKI KAISHA, Tokyo (JP)

(72) Inventor: Tomonori Hayashi, Nagareyama-shi (JP)

(21) Appl. No.: 14/789,228

(22) Filed: Jul. 1, 2015

(30) Foreign Application Priority Data
Jul. 9, 2014 (JP) 2014-141576

(51) Int. Cl. H04N 1/327; H04N 1/00

(52) U.S. Cl. CPC H04N 1/32767; H04N 1/00389; H04N 1/00413; H04N 1/00482; H04N 2201/0094; H04N 2201/0082

(57) ABSTRACT

In order to appropriately reproduce a desired setting value for each user who uses an image forming apparatus and thus improve convenience, the image forming apparatus comprises: a storing unit configured to store save destination information indicating a save destination of a file, with user information indicating a user who instructed to save the file to the save destination in the past; an accepting unit configured to accept a selection of a function of saving or printing a file from a login user; and a displaying unit configured to, in a case where the selection of the function has been accepted by the accepting unit, determine the save destination information which is associated with the user information indicating the login user and display the determined save destination information.

### BACKGROUND OF THE INVENTION

1. Field of the Invention

The present invention relates to an image forming apparatus, an information processing method, and a storage medium of storing a program to perform the information processing method.

2. Description of the Related Art

In recent years, an image forming apparatus is equipped with various functions, and the operations thereof that an operator has to perform become complex. In general, since the image forming apparatus is frequently shared by a plurality of users, an autoclear function for automatically clearing a set value after a certain period of time is used, so as to prevent an inconvenient situation that, after a user changed a setting, a next (or another) user uses the image forming apparatus without noticing that the setting has been changed. In such utilization, each user of the image forming apparatus has to select, from the initial setting, a desired setting each time. For this reason, even if the setting to be always used for each user of the image forming apparatus has been determined previously, there is troublesome because the user has to configure the same setting each time.

To solve such a problem, a customization function by which the user can freely configure the initial setting has been proposed. However, even in this function, since the user oneself has to configure the customized initial setting, there is a case where it is difficult for the user who is not accustomed to the image forming apparatus to configure the initial setting. As a result, it is necessary to provide a mechanism by which the screen displaying the setting previously used by a user can automatically be reproduced without any instruction of the user.

In the technique disclosed in Japanese Patent Application Laid-Open No. 2008-273126, when the plurality of functions are sequentially selected within the predetermined period of time after the user authentication, the contents and their selection ranking of the plurality of selected functions are associated with the respective users and then stored. Further, in this technique, when the customization information of the user is read from the customization information storing unit, the initial display screen concerning the first-selected function (first ranking) among the plurality of functions is read and displayed on the touch panel portion. Thus, by considering the function selection ranking of each of the plurality of users, it is possible to provide the initial display screen properly customized for each user.

As just described, in the technique disclosed in Japanese Patent Application Laid-Open No. 2008-273126, the function (first ranking) which was first selected previously is displayed as the initial display screen.

On another front, the recent image forming apparatus is generally equipped with a plurality of applications. Here, in a box function which is provided in a save application, it is possible to read and save an original image as a file in a box and then print the file saved in the box when needed by a user.

Further, when the user intends to print the saved file, he/she can designate imposition to print paper, settings of a finisher for stapling and the like, and output print settings such as an image quality setting for a density and the like. Therefore, the user can perform the printing with the different setting for each of the files saved in the box. For example, it is possible to perform a setting of performing single-face printing for the file related to a contract document and saved in the box and perform double-face printing for other (remaining) files.

Further, the user can simultaneously select and print the plurality of files in the box. At this time, on the operation unit 106, the user can designate the print setting usable only in case of selecting the plurality of files. More specifically, it is possible to set a “combine and print” function of combining (or collecting) the plurality of files into one and then printing it, and a “partition paper” function of automatically inserting a partition paper in the printed material consisting of the plurality of files.

Therefore, in the constitution equipped with the box function, if the box function is displayed in the initial screen and the previously used print setting is unconditionally reproduced (restored) as the display screen, the previously used print setting is reproduced even when the file different from the file in the previously used box is used. Thus, in this case, since the user has to again perform the file selection and the print setting, convenience does not necessarily improve.

The present invention aims to appropriately reproduce a desired setting value for each user who uses the image forming apparatus and thus improve convenience.

### SUMMARY OF THE INVENTION

To achieve such an object as described above, an image forming apparatus according to the present invention is characterized by comprising: a storing unit configured to store save destination information indicating a save destination of a file, with user information indicating a user who instructed to save the file to the save destination in the past; an accepting unit configured to accept a selection of a function of saving or printing a file from a login user; and a displaying unit configured to, in a case where the selection of the function has been accepted by the accepting unit, determine the save destination information which is associated with the user information indicating the login user and display the determined save destination information.

Further features of the present invention will become apparent from the following description of exemplary embodiments with reference to the attached drawings.

### BRIEF DESCRIPTION OF THE DRAWINGS

FIG. 1 is a block diagram illustrating a hardware constitution of an image forming apparatus.

FIG. 2 is a block diagram illustrating a functional constitution of the image forming apparatus.

FIGS. 3A, 3B, 3C and 3D are diagrams illustrating operation screens.

FIG. 4 is a flow chart indicating a reproduction information storing process according to the first embodiment.

FIG. 5 is a diagram illustrating reproduction information according to the first embodiment.

FIG. 6 is a flow chart indicating a setting reproducing process according to the first embodiment.

FIG. 7 is a flow chart indicating a reproduction information storing process according to the second embodiment.

FIG. 8 is a diagram illustrating reproduction information according to the second embodiment.

FIG. 9 is a flow chart (part 1) indicating a setting reproducing process according to the second embodiment.

FIG. 10 is a flow chart (part 2) indicating the setting reproducing process according to the second embodiment.

### DESCRIPTION OF THE EMBODIMENTS

Hereinafter, preferred embodiments of the present invention will be described with reference to the attached drawings.

### First Embodiment

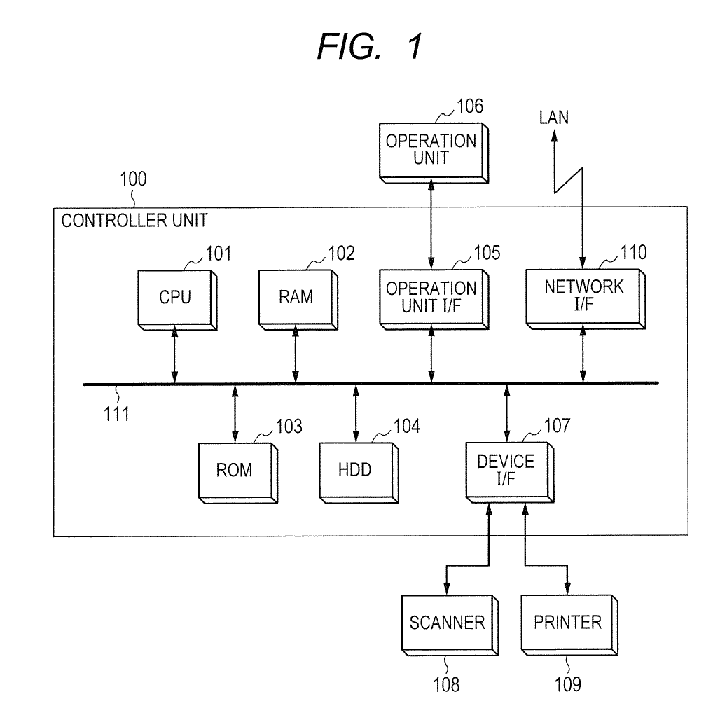

FIG. 1 is a block diagram illustrating an example of the hardware constitution of an image forming apparatus according to the present embodiment. In the drawing, a controller unit 100 is the device for entirely controlling the image forming apparatus, and a CPU (central processing unit) 101 is the arithmetic device for entirely controlling the system of the controller unit 100. More specifically, the CPU 101, an RAM (random access memory) 102, an ROM (read only memory) 103, an HDD (hard disk drive) 104, an operation unit I/F (interface) 105, a device I/F 107 and a network I/F 110 are respectively connected to a system bus 111. The CPU 101 totally controls the respective devices connected to the system bus 111. The RAM 102 is the system working memory to be used when the CPU 101 operates, and also serves as the image memory for temporarily storing image data. Moreover, programs, data and the like such as an operating system, system software, application software and the like are provided inside the RAM 102. The ROM 103 has stored a system boot program. Moreover, the ROM 103 may store a system program, an application program, and various kinds of information such as font information and the like necessary for the processes of the image forming apparatus. The HDD 104 has stored programs such as the operating system, the system software, the application software and the like, the image data, setting data and the like. The CPU 101 loads to the RAM 102 and executes the programs stored in the ROM 103 and the HDD 104, thereby achieving the later-described functional constitution of the image forming apparatus and the later-described flow chart processes (information processes) of the image forming apparatus. At that time, the CPU 101 performs the processes by using various data including the image data stored in the RAM 102, the ROM 103 and the HDD 104.

Incidentally, in the small-sized image forming apparatus, it is possible to adopt a hard-disk-less constitution in which the HDD 104 is not provided and the programs such as the system software, the application software and the like are stored in the ROM 103. Alternatively, it is possible to adopt a constitution in which, instead of the HDD 104, a memory device such as a flash memory like an SSD (solid state disk) is installed.

The controller unit 100 has the operation unit I/F 105, the device I/F 107 and the network I/F 110. The operation unit I/F 105 is connected to an operation unit 106. On the operation unit 106, a display deice such as a touch panel or the like for displaying and notifying the state of the image forming apparatus to a user and accepting operations from the user is provided, and operation buttons and the like for operating the image forming apparatus are further provided. The device I/F 107 connects the controller unit 100 to a scanner 108 and a printer 109 together serving as an image input/output device, thereby inputting and outputting image data. The image data input from the scanner 108 via the device I/F 107 is stored in the RAM 102 or the HDD 104. Then, as necessary, the stored image data is subjected to an image process or the like by the function achieved by the application program stored in the RAM 102. Likewise, the image data is output to the printer 109 via the device I/F 107. The network I/F 110 is connected to an LAN (local area network), thereby inputting/outputting image data and various information for controlling the image forming apparatus from/to external devices on the network.

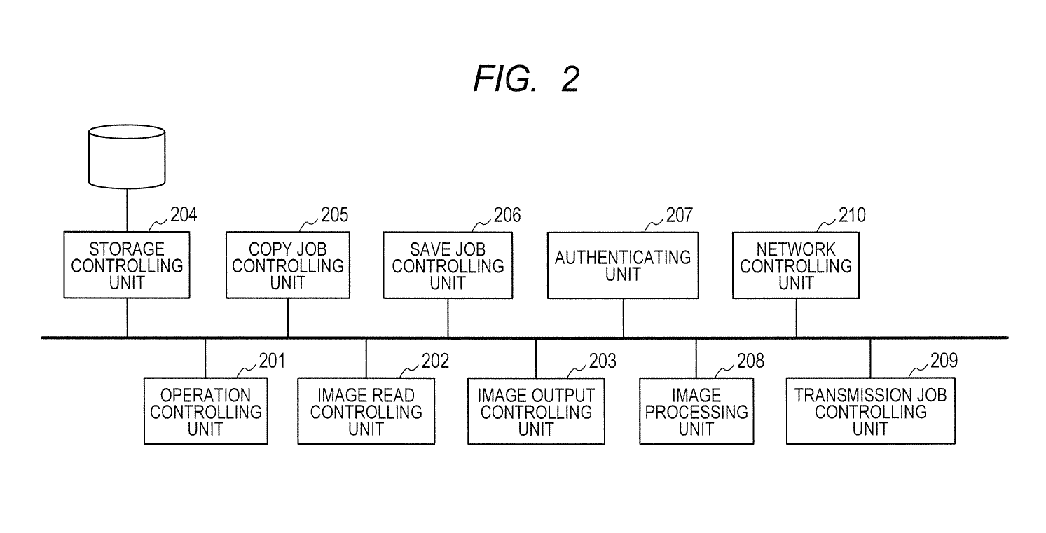

Subsequently, the functional constitution of the image forming apparatus will be described. FIG. 2 is a block diagram illustrating an example of the functional constitution of the image forming apparatus. As described above, the functional constitution illustrated in FIG. 2 is achieved on condition that the CPU 101 executes the programs stored in the ROM 103 and/or the HDD 104.

Here, printing in a copy operation will be described as an example. Although it is not illustrated, the scanner 108 is equipped with a platen and a sheet original document reading device (hereinafter, called an ADF (automatic document feeder)). If a user puts an original document on the platen or the ADF and depresses an original document reading start button (not illustrated) on the operation unit 106, the scanner 108 optically reads the original document put on the platen or the ADF. At that time, the scanner 108 reads the original document of a plurality of pages put on the platen while replacing the pages, and reads the original document of the plurality of pages put on the ADF according to the feeding operation by the ADF. At that time, the user can designate various output print settings related to imposition to paper, setting of the finisher such as a stapler, setting of image quality such as density, and the like.

An operation controlling unit 201 displays screens and information necessary for operations on the operation unit 106, receives information (input information) by user's operations from the operation unit 106, and decides which operation has been instructed. When the printing in the copy operation is requested by the user, the operation controlling unit 201 instructs to generate the screen necessary for the copy printing and display the generated screen on the operation unit 106. Thus, since the screen for the copy printing is displayed on the operation unit 106, the user sets the original document to the platen or the ADF and inputs the copy instruction via the displayed screen. At the same time, the user may instruct the above print setting. Then, the copy instruction is transferred from the operation unit 106 to the operation controlling unit 201. When the copy instruction is received from the operation unit 106, the operation controlling unit 201 starts to control a copy job controlling unit 205.

Since it is first necessary to read the original document, the copy job controlling unit 205 instructs an image read controlling unit 202 to read the original document. The image read controlling unit 202 controls the scanner 108 via the device I/F 107 to actually read the original on the platen or the ADF. Incidentally, when the original document (page thereof) is replaced on the platen, the control is returned from the copy job controlling unit 205 to the operation controlling unit 201 to again instruct the operation unit 106 to display the selection screen for selecting whether to read the next original document or start the printing. The read data is stored in the RAM 102 or the HDD 104 by a store controlling unit 204 via the device I/F 107 and the system bus 111. Incidentally, the image read controlling unit 202 determines whether to store the data in the RAM 102 or in the HDD 104, based on factors such as a data size, a demand of high-speed process and the like.

Next, since it is necessary to output the read data, the copy job controlling unit 205 instructs an image output controlling unit 203 to print the data read and stored by the store controlling unit 204. The image output controlling unit 203 instructs an image processing unit 208 to perform the image process to the data stored in the RAM 102 or the HDD 104 by the store controlling unit 204, with the print setting designated by the user. For example, the image process is output image editing such as “2-in-1” imposition of imposing two original documents onto one paper. After completing the output image editing, the image processing unit 208 transfers the edited image data to the store controlling unit 204. Then, the store controlling unit 204 stores the edited image data transferred from the image processing unit 208.

The image output controlling unit 203 reads the image data subjected to the image process from the RAM 102 or the HDD 104 via the store controlling unit 204, and transfers the read image data to the printer 109 via the system bus 111 and the device I/F 107. The printer 109 sequentially prints and outputs, to papers, the image data received from the image output controlling unit 203. A network controlling unit 210 controls communication with an external device on the network via the network I/F 110.

An authenticating unit 207 performs an authenticating process which is necessary when the user uses the image forming apparatus. For example, the authenticating unit 207 displays, on the operation unit 106, a screen which is used when the user inputs a user name and a password. Then, if the user inputs the user name and the password on the operation unit 106, the user name and the password respectively input by the user are transferred to the authenticating unit 207 via the operation unit I/F 105. The authenticating unit 207 checks whether or not each of the input user name and the input password coincides with the data in the user database stored in the storage area of the image forming apparatus, thereby authenticating the user. Incidentally, the authenticating method is not limited to that as described above, and it may be possible to use a known method using a non-contact IC card. Besides, it is unnecessary to locally prepare the authentication information. For example, it may be possible to adopt an authenticating system such as Active Directory™ available by Microsoft' of performing authentication with use of an external authentication server. In such a case, the authenticating unit 207 sends a query to the external authentication server to perform the authentication.

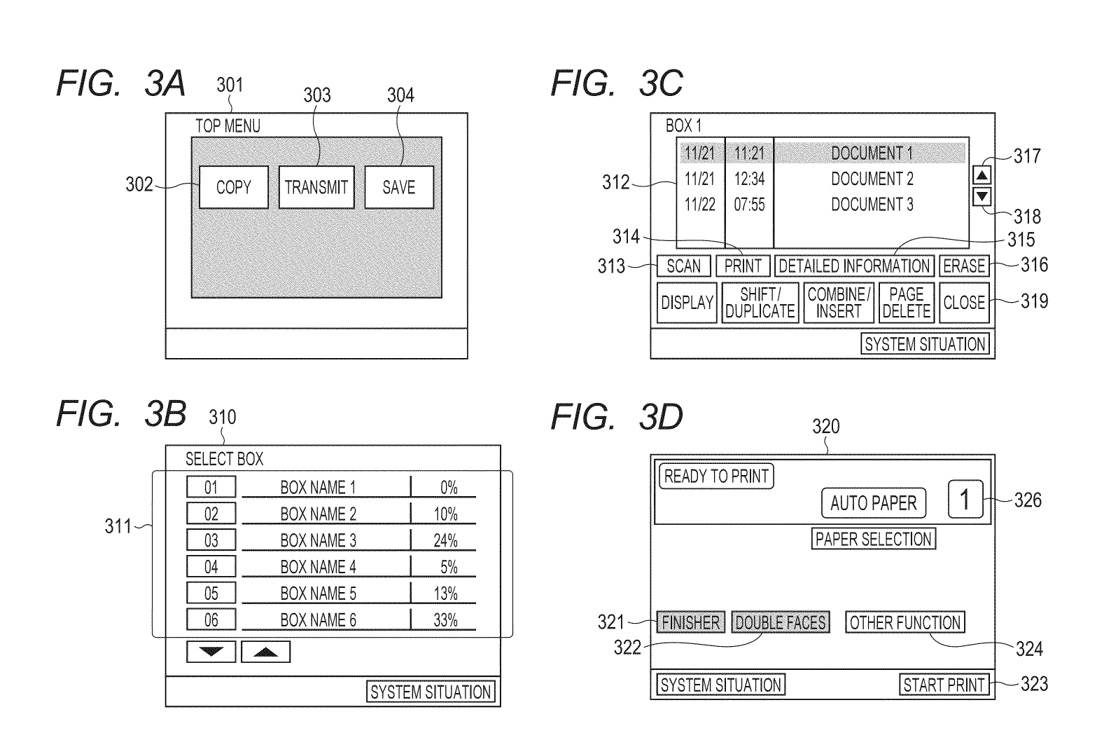

Incidentally, since the copy printing has been exemplarily explained here, descriptions of a save job controlling unit 206 and a transmission job controlling unit 209 are omitted. The save job controlling unit 206 and the transmission job controlling unit 209 are the controlling units respectively corresponding to a storage application and a transmission application activated by user's operations on operation screens later described with reference to FIGS. 3A to 3D. Therefore, these controlling units will be described later in detail.

Subsequently, the contents displayed on the operation unit 106 of the image forming apparatus will be described with reference to FIGS. 3A to 3D. FIGS. 3A to 3D are the diagrams exemplarily illustrating the operation screens to be displayed on the operation unit 106 of the image forming apparatus.

In FIG. 3A, a top menu 301 is displayed as an initial screen when the image forming apparatus is powered on. If a copy application selection key 302 is selected, the screen is transitioned to a copy screen. If a transmission application selection key 303 is selected, the screen is transitioned to a transmission screen. If a save application selection key 304 is selected, the screen is transitioned to a save screen. Here, a save application is the application by which the image data input from the scanner 108 of the image forming apparatus via the device I/F 107 is stored in the HDD 104 under the control of the store controlling unit 204 and the printing process is performed to the stored image data at timing desired by the user.

FIG. 3B illustrates a screen 310 of the save application. That is, the user selects a data (file) save destination called a box 311 displayed on the screen 310. In the example illustrated in FIG. 3B, the box names and usage of the respective boxes (in percentages) are displayed.

FIG. 3C illustrates the display to be displayed when the box is selected as the save destination on the screen 310 illustrated in FIG. 3B. More specifically, in a file (document) list 312 of the box, the registration date and hours of respective files and their file names are list-displayed. When selecting the file, the user depresses the file name. Incidentally, the file currently selected is highlighted. Besides, the user may select the plurality of files simultaneously.

A scan key 313 is depressed (selected) when the image is input from the scanner 108 to the currently opened box. In response to depression of the scan key 313, the screen is transitioned to a not-illustrated scan setting screen. A print key 314 is depressed to print the file selected in the file list 312. A detailed information key 315 is depressed when the user intends to confirm the detailed information of the file selected in the file list 312. For example, the detailed information key is depressed to confirm the number of pages, a print mode currently set, and the like. An erase key 316 is depressed to erase the file selected in the file list 312. Up and down scroll keys 317 and 318 are respectively depressed to scroll the screen when the files of which the number exceeds the displayable value in the display area have been registered in the file list 312. A close key 319 is depressed to return the current screen to the screen 310 illustrated in FIG. 3B. Incidentally, the descriptions of respective modes which are not directly relative to the present embodiment will be omitted.

FIG. 3D illustrates a print setting screen 320 of the save application. On the print setting screen 320, the user can designate various output print settings related to imposition to paper, the setting of the finisher such as stapling, the setting of the image quality such as density, and the like. In the example illustrated in FIG. 3D, the keys to which the settings have been completed are highlighted.

A double-face key 322 is depressed to set a double-face mode. In the example of the screen, the double-face mode has been set. A finisher key 321 is depressed to set a sorting mode and a stapling mode. In the example of the screen, the finisher mode has been set. A section 326 is used to display the setting of the number of prints. The user can set the number of prints by inputting a numerical value with use of the numeric keypad or the like on the operation unit 106. In the example of the screen, the number of prints is set to “1”. An other function key 324 is depressed to designate other print settings for print modes settable in the imposition to paper, the printing of a plurality of files, and the like. Here, as the print mode in the printing of the plurality of files, it is possible to set a “combine and print” mode for combining the plurality of files into one and then printing, and a “partition paper” mode for automatically inserting a partition paper in the printed material of the plurality of files. If a print start key 323 is depressed in this state, then the save job controlling unit 206 concludes that a job start was instructed, reads the corresponding file (document) saved by the storage controlling unit 204, and performs the printing according to the provided print setting. Incidentally, the descriptions of respective modes which are not directly relative to the present embodiment will be omitted.

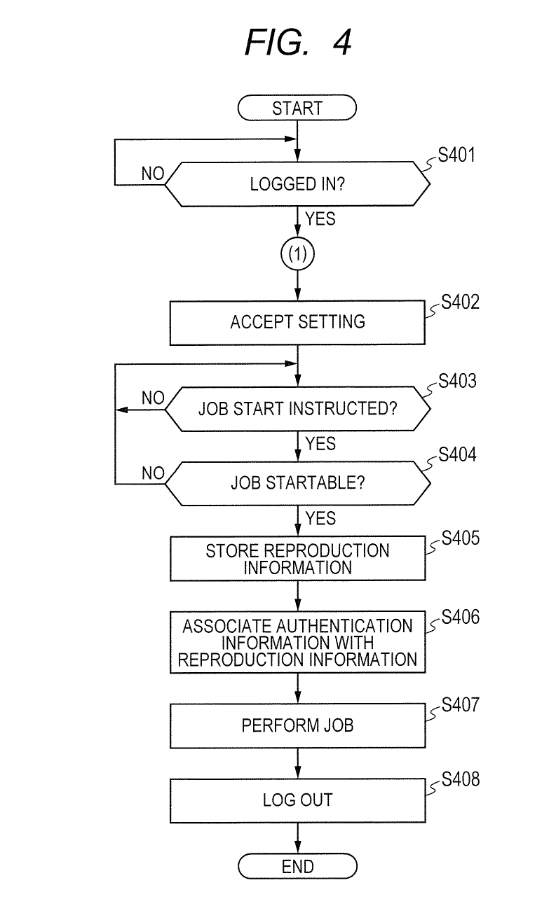

FIG. 4 is a flow chart exemplarily indicating a reproduction information storing process which is necessary to reproduce (restore) the setting (process setting) of the image forming apparatus according to the present embodiment.

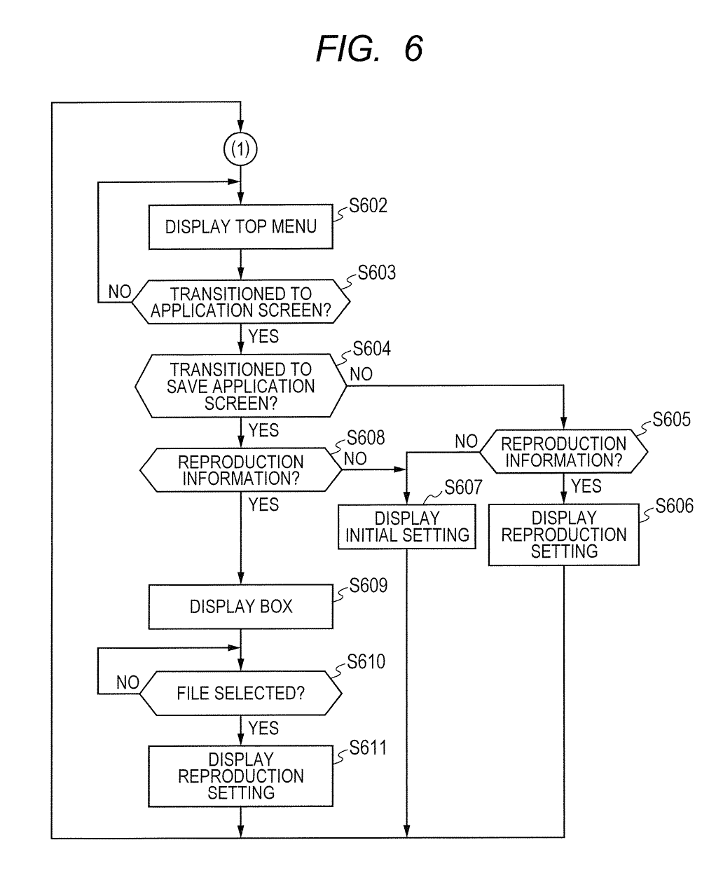

In S401, the authenticating unit 207 performs the authenticating process for the user. Since the authenticating process has already been described as above in detail, the description thereof is omitted here. If the authentication is successful and thus the user logs in, the authenticating unit 207 advances the process to a next step. In the next step, when reproduction information has already been stored, a reproducing process to reproduce the setting is performed, so that the application screen is displayed. The detail of the reproducing process will be described later with reference to FIG. 6.

In S402, the operation controlling unit 201 accepts the print setting, the original document reading setting and the like on the application screen.

In S403, the operation controlling unit 201 decides whether or not the job start is instructed. Here, when a start key (not illustrated) or the print start key 323 on the print setting screen 320 illustrated in FIG. 3D is depressed, the operation controlling unit 201 decides that the job start is instructed. Then, if it is decided by the operation controlling unit 201 that the job start is instructed, the process is advanced to S404. Incidentally, in the job start, the job controlling unit for each application starts the operation according to the set information when the start key (not illustrated) or the print start key 323 is depressed on the print setting screen 320.

In S404, the operation controlling unit 201 first identifies the application to which the job start was instructed in S403. More specifically, the operation controlling unit 201 identifies the application corresponding to the key depressed on the top menu 301 of FIG. 3A. Then, the operation controlling unit 201 decides whether or not the setting information in the identified application indicates the setting by which the job can be started (job startable).

Here, the operation controlling unit 201 may previously control to disable the user to set a combination of the settings by which the job cannot be started, so as to surely decide, when the job start instruction was accepted in S403, that the accepted setting information indicates the setting by which the job can be started. In this case, the setting information related to the combination of the settings by which the job can be started (job operable) may previously be determined and stored in the HDD 104.

Moreover, the operation controlling unit 201 may decide whether or not the provided setting information indicates the setting by which the job can be started, by the job controlling unit of the identified application. More specifically, it is decided whether or not the provided setting information has been decided as the setting information by which the corresponding job controlling unit can perform. Here, the job controlling unit implies the copy job controlling unit 205, the save job controlling unit 206 and the transmission job controlling unit 209.

If it is decided in S404 by the operation controlling unit 201 that the provided setting information indicates the setting by which the job can be started, the process is advanced to S405. On the other hand, if it is decided that the provided setting information does not indicate the setting by which the job can be started, the process is returned to S403.

In S405, the storage controlling unit 204 stores the setting information provided in the application identified in S404 and the number information of the used box as the reproduction information of the corresponding application, in the RAM 102 or the HDD 104. For example, if the application identified in S404 is the save application and the settings shown on the print setting screen 320 of FIG. 3D are provided, the reproduction information which includes the setting information indicating that the double-face mode and the finisher mode are activated is stored. Incidentally, the number information of the box is an example of save destination information indicating a save destination of the file that the user instructed save in the past.

In S406, the storage controlling unit 204 associates the authentication information (user identifier) obtained in the authenticating process of S401 with the reproduction information stored in S405 and then stores the obtained information in the RAM 102 or the HDD 104. When the reproduction information of the application of the corresponding user has already been stored at this time, the storage controlling unit 204 stores the latest reproduction information.

In S407, the job controlling unit of the application identified in S404 performs the job according to the provided setting information. Incidentally, the reproduction information is stored at timing of job start in the present embodiment. However, it is also possible to store the reproduction information at another timing when the application of the image forming apparatus is changed over, when a reset button is depressed, when a logout button is depressed, or the like.

In S408, if the user ends the use of the image forming apparatus and inputs a logout instruction, the operation controlling unit 201 transitions the screen to the login standby screen.

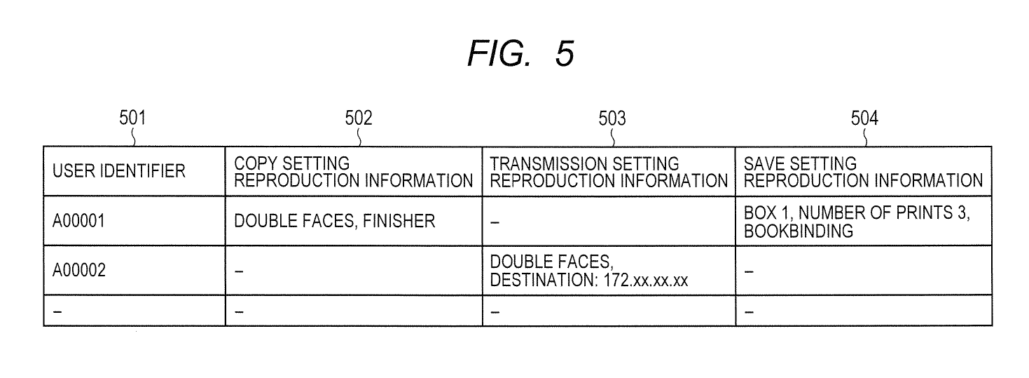

FIG. 5 is a diagram illustrating an example of the reproduction information according to the present embodiment. As illustrated in the example of FIG. 5, the reproduction information includes a user identifier 501 of the login user, and the reproduction information in each application of the login user. The reproduction information is stored in the RAM 102 or the HDD 104 by the storage controlling unit 204. Since the user identifier 501 is the information for uniquely identifying the login user, the value different for each user is set as the user identifier.

Copy setting reproduction information 502 is the reproduction information in the copy application. In the example of FIG. 5, the reproduction information related to the double-face mode and the finisher mode has been stored as the copy setting reproduction information 502 of A00001 of the user identifier 501. Further, in the example of FIG. 5, the copy setting reproduction information 502 of A00002 of the user identifier 501 is not yet stored.

Transmission setting reproduction information 503 is the reproduction information in the transmission application. In the example of FIG. 5, the reproduction information related to the double-face mode and the destination has been stored as the transmission setting reproduction information 503 of A00002 of the user identifier 501.

Save setting reproduction information 504 is the reproduction information in the save application. In the example of FIG. 5, the number information of the used box and the setting information indicating “number of prints 3” as the print setting and “bookbinding” as the setting of imposition to paper have been stored as the save setting reproduction information 504 of A00001 of the user identifier 501.

Incidentally, in the example of FIG. 5, only the difference information from the initial setting is stored as each of the copy setting reproduction information 502, the transmission setting reproduction information 503 and the save setting reproduction information 504. However, all pieces of the information including the initial setting may be stored and held.

FIG. 6 is a flow chart indicating an example of a setting reproducing process of reproducing the setting (process setting) of the image forming apparatus according to the present embodiment.

If the authentication is successful and the user logs in to the image forming apparatus in S401 of FIG. 4, in S602, the operation controlling unit 201 displays the top menu 301 illustrated in FIG. 3A.

In S603, the operation controlling unit 201 decides whether or not there is an instruction of the user to display the application screen. More specifically, the operation controlling unit 201 decides whether or not there is the instruction of the user to display the application screen, in response to acceptance of the input on the top menu 301 illustrated in FIG. 3A. If it is decided by the operation controlling unit 201 that there is the instruction to display the application screen, the process is advanced to S604.

In S604, the operation controlling unit 201 decides whether or not the application for which the display was instructed in S603 is the save application. More specifically, the operation controlling unit 201 decides whether or not the application for which the display was instructed in S603 is the save application, according to decision as to whether or not the save application selection key 304 is selected on the top menu 301 illustrated in FIG. 3A. If it is decided by the operation controlling unit 201 that there is the instruction to display the save application, the process is advanced to S608. On the other hand, if it is decided that there is an instruction to display another application, the process is advanced to S605. In other words, in S604, the operation controlling unit 201 decides which process is instructed.

In S605, the operation controlling unit 201 decides, by confirming with the storage controlling unit 204, whether or not the reproduction information associated with the user identifier which coincides with the user identifier of the user who logged in to the image forming apparatus in S401 exists. As a result of the confirmation, if the relevant reproduction information exists, the operation controlling unit 201 further decides, by confirming with the storage controlling unit 204, whether or not the reproduction information for the application for which the display was instructed in S603 exists. If it is decided by the operation controlling unit 201 that the reproduction information for the application for which the display was instructed exists, the process is advanced to S606. On the other hand, if it is decided that the reproduction information for the application for which the display was instructed does not exist, the process is advanced to S607.

In S606, the operation controlling unit 201 reads the reproduction information identified in S605 via the storage controlling unit 204, and reproduces the read reproduction information on the screen of the application for which the display was instructed in S603. Thus, it is possible to automatically reproduce the previously used setting, without a user's instruction.

In S607, since it has been decided that the reproduction information for the application for which the display was instructed does not exist, the operation controlling unit 201 displays, as the initial setting, the screen of the application for which the display was instructed in S603 (i.e., an initial setting displaying process).

In S608, the operation controlling unit 201 decides, by confirming with the storage controlling unit 204, whether or not the reproduction information associated with the user identifier which coincides with the user identifier of the user who logged in to the image forming apparatus in S401 exists. As a result of the confirmation, if it is decided by the operation controlling unit 201 that the relevant reproduction information exists, the process is advanced to S609. On the other hand, if it is decided that the relevant reproduction information does not exist, the process is advanced to S607.

In S609, the operation controlling unit 201 reads the reproduction information identified in S608 via the storage controlling unit 204, and displays the box having the box number indicated by the reproduction information.

In S610, the operation controlling unit 201 decides whether or not the print-target file (file to be printed) saved in the box of the save application is selected. If it is decided by the operation controlling unit 201 that the print-target file is selected, the process is advanced to S611.

In S611, the operation controlling unit 201 reads the setting information of the print setting of the file selected in S610 from the storage controlling unit 204, and reproduces the read setting information on the save application screen. Thus, it is possible to automatically reproduce the print setting of the file. More specifically, a case where the reproduction information indicated in FIG. has been saved will be described hereinafter. It is assumed that the user corresponding to the user identifier A00001 logged in to the image forming apparatus in S401 and it was instructed in S603 to transition to the save application screen. In this case, the screen of the box 1 indicated by the save setting reproduction information 504 of A00001 of the user identifier 501 of FIG. 5 is reproduced. Then, if the file is selected, the screen in the state that the print settings of “number of prints 3” and “bookbinding” have been selected is reproduced.

As described above, according to the present embodiment, it is possible to properly reproduce the desired setting value for each user who uses the image forming apparatus, and it is thus possible to improve convenience. In particular, even in the case where the printing is performed using the function of the save application provided in the image forming apparatus, it is possible to properly reproduce the desired setting value for each user.

### Second Embodiment

In the first embodiment, the reproduction flow in which the number of files selected in the save application is not considered has been described. However, the settable print setting for a single file is different from that for a plurality of files. For this reason, it is possible to respectively store the setting information of the print setting for the single file and the setting information of the print setting for the plurality of files and thus reproduce the appropriate print setting according to the number of selected files. In the present embodiment, a process to be performed in such a case will be described. Incidentally, it is assumed that the hardware and functional constitutions of the image forming apparatus are the same as those described in the first embodiment.

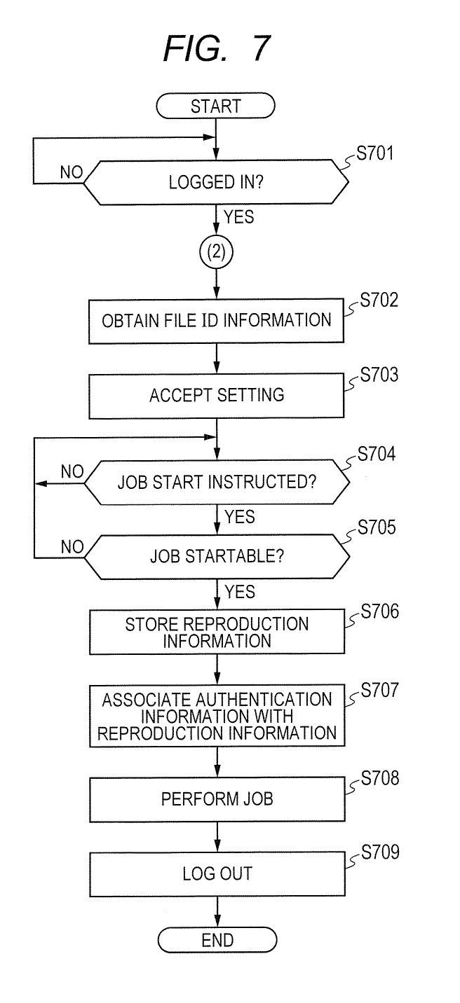

FIG. 7 is a flow chart exemplarily indicating a reproduction information storing process which is necessary to reproduce the setting (process setting) of the image forming apparatus according to the present embodiment.

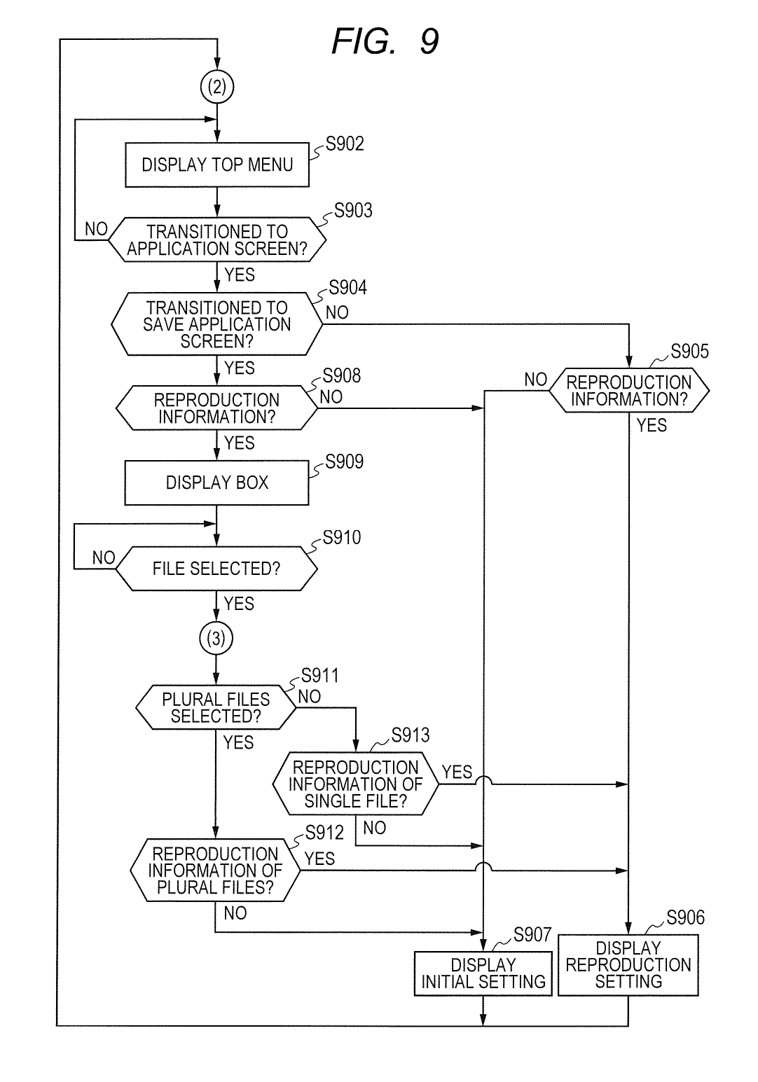

In S701, the authenticating unit 207 performs the authenticating process for a user. If the authentication by the authenticating unit 207 is successful and thus the user logs in, the process is advanced to a next step. In the next step, when the reproduction information has already been stored, the reproducing process to reproduce the setting is performed, and the application screen is displayed. The detail of the reproducing process will be described later with reference to FIG. 9.

In S702, the operation controlling unit 201 obtains the file ID information for identifying the file selected on the save application screen from the save job controlling unit 206. Here, if the plurality of files are selected, the file ID information for each file is obtained in order of selection.

In S703, the operation controlling unit 201 accepts the print setting on the save application screen.

In S704, the operation controlling unit 201 decides whether or not the job start is instructed. Since the deciding method in S704 is the same as the previously described deciding method in S403, the detailed description thereof will be omitted. Then, if it is decided by the operation controlling unit 201 that the job start is instructed, the process is advanced to S705.

In S705, the operation controlling unit 201 decides whether or not the provided setting information indicates the setting by which the job can be started (job startable). Since the deciding method in S705 is the same as the previously described deciding method in S404, the detailed description thereof will be omitted. If it is decided by the operation controlling unit 201 that the setting information indicates the setting by which the job can be started, the process is advanced to S706. On the other hand, if it is decided that the setting information does not indicate the setting by which the job can be started, the process is returned to S704.

In S706, the storage controlling unit 204 stores the setting information provided in the save application and the number information of the used box as the reproduction information of the save application in the RAM 102 or the HDD 104. At this time, the storage controlling unit 204 includes the file ID information obtained in S702 into the reproduction information and then stores the obtained reproduction information. If the file ID information of the plurality of files is obtained in S702, the storage controlling unit 204 stores the file ID information in order of selection. Incidentally, the file ID information is an example of file identification information for identifying the file.

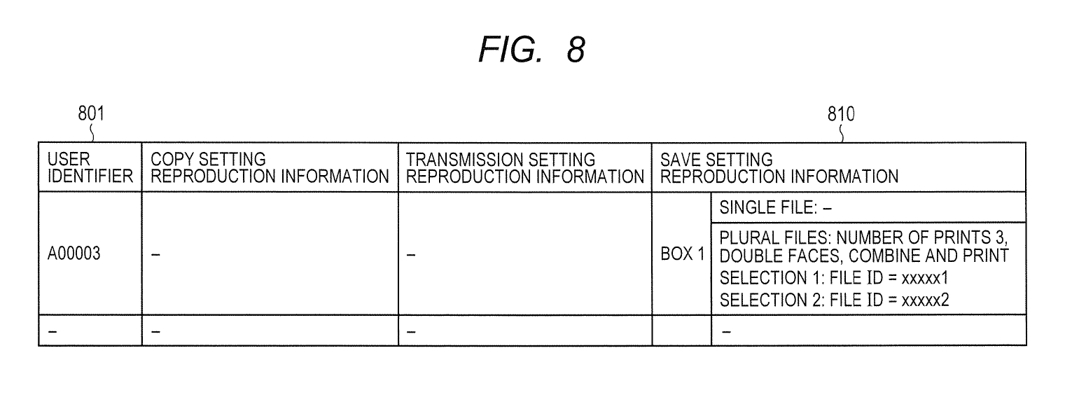

In S707, the storage controlling unit 204 associates the authentication information (user identifier) obtained by the authenticating process in S701 with the reproduction information stored in S706, and stores the associated information in the RAM 102 or the HDD 104. For example, it is assumed that the documents 1 and 2 are selected in order of the documents 1 and 2 in the file list 312 of FIG. 3C in the save application. Further, it is assumed that, on the print setting screen 320 of FIG. 3D, “3” is set as the number of prints, the double-face mode is set, and “combine and print” (not illustrated) is set by the other function key 324. In that case, the storage controlling unit 204 stores the reproduction information later described with reference to FIG. 8. When the reproduction information of the save application of the user has already been stored at this time, the storage controlling unit 204 stores the latest reproduction information. However, the storage controlling unit 204 stores the reproduction information of the single file and the reproduction information of the plurality of files respectively in different storage areas. Therefore, even when the reproduction information of the single file in the save application of the corresponding user has already been stored, the storage controlling unit 204 can add and store the reproduction information of the plurality of files.

In S708, the save job controlling unit 206 performs the job according to the provided setting information. In the present embodiment, the reproduction information is stored at timing of job start. However, as well as the process indicated by the flow chart in FIG. 4, it is also possible to store the reproduction information at another timing when the application of the image forming apparatus is changed over.

In S709, if the user ends the use of the image forming apparatus and inputs a logout instruction, the operation controlling unit 201 transitions the screen to the login standby screen.

FIG. 8 is a diagram illustrating an example of the reproduction information according to the present embodiment. As illustrated in the example of FIG. 8, the reproduction information includes a user identifier 801 of the login user, and the reproduction information in each application of the login user. The reproduction information is stored in the RAM 102 or the HDD 104 by the storage controlling unit 204. Hereinafter, the description of the information same as that illustrated in FIG. 5 will be omitted.

Save setting reproduction information 810 is the reproduction information in the save application. In the example illustrated in FIG. 8, the number information of the used box, the file ID information for identifying the used file, and the setting information indicating “number of prints 3”, “double faces” and “combine and print” as the print settings have been stored as the save setting reproduction information 810 of A00003 of the user identifier 801. When the plurality of files are used, also the order of the selected files has been stored. Incidentally, the setting information of the print setting is stored for each of the case where the single file is used and the case where the plurality of files are used, but the number information of the used box is stored commonly for both the cases. The example illustrated in FIG. 8 indicates that the print setting of the single file is not yet stored. The file ID information is the information for uniquely identifying the file, and thus the value different for each file is set as the file ID information.

FIG. 9 is a flow chart exemplarily indicating a setting reproducing process of reproducing the setting (process setting) of the image forming apparatus according to the present embodiment. In particular, the relevant flow chart indicates the process of changing over the reproduction information according to the number of selected files in the save application.

If the authentication is successful and thus the user logs in to the image forming apparatus in S701 of FIG. 7, in S902, the operation controlling unit 201 displays the top menu 301 illustrated in FIG. 3A.

In S903, the operation controlling unit 201 decides whether or not there is an instruction of the user to display the application screen. Since the deciding method in S903 is the same as the above deciding method in S603, the detailed description thereof will be omitted. If it is decided by the operation controlling unit 201 that there is the instruction to display the application screen, the process is advanced to S904.

In S904, the operation controlling unit 201 decides whether or not the application for which the display was instructed in S903 is the save application. Since the deciding method in S904 is the same as the above deciding method in S604, the detailed description thereof will be omitted. If it is decided by the operation controlling unit 201 that there is the instruction to display the save application, the process is advanced to S908. On the other hand, if it is decided that there is an instruction to display another application, the process is advanced to S905. In other words, in S904, the operation controlling unit 201 decides which process is instructed.

In S905, the operation controlling unit 201 decides, by confirming with the storage controlling unit 204, whether or not the reproduction information associated with the user identifier which coincides with the user identifier of the user who logged in to the image forming apparatus in S701 exists. As a result of the confirmation, if the relevant reproduction information exists, the operation controlling unit 201 further decides, by confirming with the storage controlling unit 204, whether or not the reproduction information for the application for which the display was instructed in S903 exists. If it is decided by the operation controlling unit 201 that the reproduction information for the application for which the display was instructed exists, the process is advanced to S906. On the other hand, if it is decided that the relevant reproduction information does not exist, the process is advanced to S907.

In S906, the operation controlling unit 201 reads the reproduction information identified in S905 via the storage controlling unit 204, and reproduces the read reproduction information on the screen of the application for which the display was instructed in S903. Thus, it is possible to automatically reproduce the previously used setting, without a user's instruction.

In S907, since it has been decided that the reproduction information does not exist, the operation controlling unit 201 displays, as the initial setting, the screen of the application for which the display was instructed in S903 (initial setting displaying process).

In S908, the operation controlling unit 201 decides, by confirming with the storage controlling unit 204, whether or not the reproduction information associated with the user identifier which coincides with the user identifier of the user who logged in to the image forming apparatus in S701 exists. As a result of the confirmation, if it is decided by the operation controlling unit 201 that the relevant reproduction information exists, the process is advanced to S909. On the other hand, if it is decided that the relevant reproduction information does not exist, the process is advanced to S907.

In S909, the operation controlling unit 201 reads the reproduction information identified in S908 via the storage controlling unit 204, and displays the box of the stored box number.

In S910, the operation controlling unit 201 decides whether or not the print-target file saved in the box of the save application is selected. If it is decided by the operation controlling unit 201 that the print-target file is selected, the process is advanced to S911.

In S911, the operation controlling unit 201 decides whether or not the plurality of files were selected in S910. If it is decided by the operation controlling unit 201 that the plurality of files were selected, the process is advanced to S912. On the other hand, if it is decided that the plurality of files were not selected but the single file is selected, the process is advanced to S913.

In S912, the operation controlling unit 201 confirms and decides whether or not the save setting reproduction information 810 of the plurality of files exits in the reproduction information identified in S908. If it is decided by the operation controlling unit 201 that the save setting reproduction information concerned exists, the process is advanced to S906 to reproduce the print setting based on the reproduction information. On the other hand, if it is decided that the save setting reproduction information concerned does not exist, the process is advanced to S907 to display the application screen with the initial setting.

In S913, the operation controlling unit 201 confirms and decides whether or not the save setting reproduction information 810 of the single file exits in the reproduction information identified in S908. If it is decided by the operation controlling unit 201 that the save setting reproduction information concerned exists, the process is advanced to S906 to reproduce the print setting based on the reproduction information. On the other hand, if it is decided that the save setting reproduction information concerned does not exist, the process is advanced to S907 to display the application screen with the initial setting.

Thus, even if the setting by which the printing is possible for the single file is different from that for the plurality of files, it is possible to reproduce the desired print setting and thus improve convenience.

More specifically, a case where the reproduction information indicated in FIG. 8 has been saved will be described hereinafter. It is assumed that the user corresponding to user identifier A00003 logged in to the image forming apparatus in S701 and it was instructed in S903 to transition to the save application screen. In this case, the screen of the box 1 indicated by the save setting reproduction information 810 of A00003 of the user identifier 801 of FIG. 8 is reproduced. After then, if the plurality of files are selected by the user, the screen in the state that the print settings of “number of prints 3”, “double faces” and “combine and print” have been selected is reproduced.

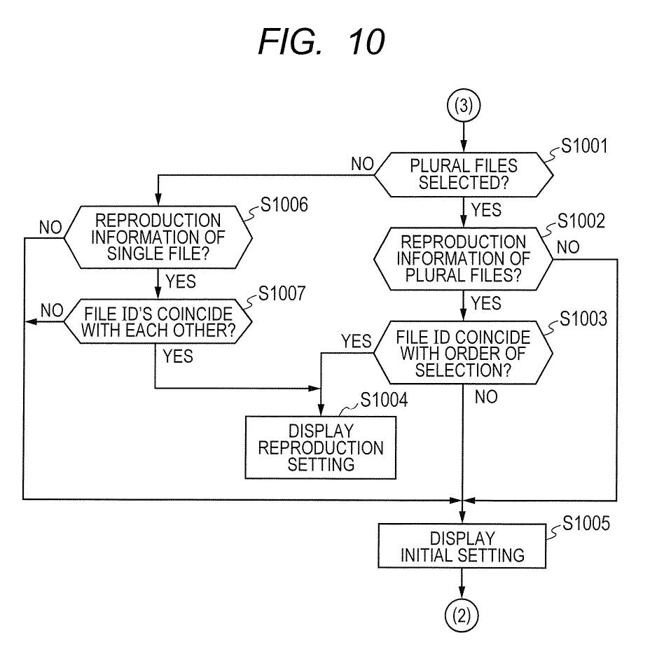

In the above process flow of FIG. 9, the setting is reproduced without deciding whether or not the file same as the file previously used has been selected. On the other hand, it is also possible to reproduce the save setting reproduction information 810 only in a case where the file previously used coincides with the file used this time. A process to be performed in this case will be described with reference to FIG. 10. Namely, FIG. 10 is the flow chart indicating an example of the process subsequent to (3) in FIG. 9.

In S1001, the operation controlling unit 201 decides whether or not the plurality of files were selected in S910. If it is decided by the operation controlling unit 201 that the plurality of files were selected, the process is advanced to S1002. On the other hand, if it is decided that the plurality of files were not selected but the single file was selected, the process is advanced to S1006. In S1002, the operation controlling unit 201 confirms and decides whether or not the save setting reproduction information 810 of the plurality of files exits in the reproduction information identified in S908. If it is decided by the operation controlling unit 201 that the save setting reproduction information concerned exists, the process is advanced to S1003. On the other hand, if it is decided that the save setting reproduction information concerned does not exist, the process is advanced to S1005 to display the application screen with the initial setting (initial setting displaying process).

In S1003, the operation controlling unit 201 obtains, via the save job controlling unit 206, the file ID information of the file selected in S910, and decides whether or not the obtained file ID information coincides with the file ID information indicated by the save setting reproduction information 810. If the obtained file ID information coincides with the file ID information indicated by the save setting reproduction information, then the operation controlling unit 201 further decides whether or not the file selection order of the obtained file ID information coincides with the file selection order of the file ID information indicated by the save setting reproduction information. If both the coincidences are decided by the operation controlling unit 201, the process is advanced to S1004 to reproduce the print setting based on the reproduction information. On the other hand, if each or both the coincidences are not decided, the process is advanced to S1005 in which the operation controlling unit 201 displays the application screen with the initial setting.

In S1006, the operation controlling unit 201 confirms and decides whether or not the save setting reproduction information 810 of the single file exits in the reproduction information identified in S908. If it is decided by the operation controlling unit 201 that the save setting reproduction information concerned exists, the process is advanced to S1007. On the other hand, if it is decided that the save setting reproduction information concerned does not exist, the process is advanced to S1005 to display the application screen with the initial setting.

In S1007, the operation controlling unit 201 obtains, via the save job controlling unit 206, the file ID information of the file selected in S910, and decides whether or not the obtained file ID information coincides with the file ID information indicated by the save setting reproduction information 810. If it is decided by the operation controlling unit 201 that the obtained file ID information coincides with the file ID information indicated by the save setting reproduction information, the process is advanced to S1004 to reproduce the print setting based on the reproduction information. On the other hand, if it is decided that the obtained file ID information does not coincide with the file ID information indicated by the save setting reproduction information, the process is advanced to S1005 to display the application screen with the initial setting.

By the above process flow, the setting is reproduced only in the case where the file same as the file previously used is selected. Further, when the plurality of files are selected, the setting is reproduced only in the case where the order of selection coincides with the previous order of selection. By doing so, since it is possible to easily reproduce the print setting desired by the user who changes the print setting for each file, it is possible to improve convenience for the user.

It may be possible for the user to change over the process flow between the process follow (process flow subsequent to (3)) of FIG. 9 and the process flow of FIG. 10. In this case, for example, it may be possible as the changeover method to use a method of previously designating by which control the print setting should be reproduced. Alternatively, it may be possible to use a method of causing the user to select the appropriate process flow via the operation unit 106 when reproducing the print setting.

Moreover, when the save setting reproduction information 810 of the plurality of files and the save setting reproduction information 810 of the single file are saved, it may be possible for the operation controlling unit 201 to reproduce the print setting which can be set commonly in both the plurality of files and the single file from both the two pieces of reproduction information. In this case, it is assumed that the print setting which can be set commonly in both the plurality of files and the single file has previously been determined. Thus, since the print setting capable of being set irrespective of the selected file(s), it is possible to improve convenience for the user.

As just described above, according to the present embodiment, in the save application, even if the setting by which the printing is possible for the single file is different from that for the plurality of files, it is possible for the user to reproduce the desired setting. Moreover, even in the case where the user changes the print setting for each file in the box, it is possible to reproduce the setting desired by the user. In this manner, it is possible to appropriately reproduce the desired setting value for each user and thus improve convenience.

According to the above-described embodiments, it is possible to appropriately reproduce the desired setting value of each user who uses the image forming apparatus, thereby improving convenience.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-141576, filed Jul. 9, 2014, which is hereby incorporated by reference herein in its entirety.

What is claimed is:

1. An image forming apparatus comprising:
a storing unit configured to store save destination information indicating a save destination of a file, with user information indicating a user who instructed to save the file to the save destination in the past;
an accepting unit configured to accept a selection of a function of saving or printing a file from a login user; and
a displaying unit configured to, in a case where the selection of the function has been accepted by the accepting unit, determine the save destination information which is associated with the user information indicating the login user and display the determined save destination information.

2. The image forming apparatus according to claim 1, wherein
the storing unit associates the save destination information indicating the save destination of the file and setting information at a time when the user used the function with the user, and stores the save destination information and the setting information as reproduction information for reproducing a process setting, and
the image forming apparatus further comprises a reproducing unit configured to reproduce the process setting of the file selected from the save destination information displayed by the displaying unit, based on the setting information associated with the save destination information indicating the save destination.

3. The image forming apparatus according to claim 2, wherein
the storing unit stores first reproduction information for reproducing the process setting of the single file and second reproduction information for reproducing the process setting of the plurality of files, and
the reproducing unit reproduces, in a case where the single file is selected from the displayed save destination, the process setting on the basis of the setting information associated with the save destination information indicating the save destination included in the first reproduction information, and reproduces, in a case where the plurality of files are selected, the process setting on the basis of the setting information associated with the save destination information indicating the save destination included in the second reproduction information.

4. The image forming apparatus according to claim 2, wherein
the storing unit stores first reproduction information for reproducing the process setting of the single file and second reproduction information for reproducing the process setting of the plurality of files, and
the reproducing unit reproduces, as the process setting of the file selected from the displayed save destination, the process setting capable of being set commonly in the single file and the plurality of files, on the basis of the setting information associated with the save destination information indicating the save destination included in the first reproduction information and the setting information associated with the save destination information indicating the save destination included in the second reproduction information.

5. The image forming apparatus according to claim 2, wherein
the storing unit stores the reproduction information which further includes file identification information for identifying the file used by the user in the function, and
the reproducing unit reproduces, in a case where it is decided based on the file identification information included in the reproduction information that the file same as the previously used file is selected from the displayed save destination, the process setting of the selected file on the basis of the setting information associated with the save destination information indicating the save destination included in the reproduction information.

6. The image forming apparatus according to claim 5, wherein
the storing unit stores, in a case where the plurality of files were used in the function, the reproduction information which includes the file identification information in order of use of the files, and
the reproducing unit reproduces, in a case where it is decided based on the file identification information included in the reproduction information and order of storage that the files same as the plurality of files previously used were selected in the same order from the displayed save destination, the process setting of the selected file on the basis of the setting information associated with the save destination information indicating the save destination included in the reproduction information.

7. The image forming apparatus according to claim 1, further comprising an initial setting displaying unit configured to display an initial setting in a case where it is decided that the function has been selected and the save destination information associated with the login user is not stored by the storing unit.

8. An information processing method to be performed by an image forming apparatus, the method comprising:
storing save destination information indicating a save destination of a file, with user information indicating a user who instructed to save the file to the save destination in the past;
accepting a selection of a function of saving or printing a file from a login user; and
in a case where the selection of the function has been accepted, determining the save destination information which is associated with the user information indicating the login user and displaying the determined save destination information.

9. A non-transitory computer-readable storage medium which stores a program to cause a computer to perform:
a storing step of storing save destination information indicating a save destination of a file, with user information indicating a user who instructed to save the file to the save destination in the past;
an accepting step of accepting a selection of a function of saving or printing a file from a login user; and
a displaying step of, in a case where the selection of the function has been accepted in the accepting step, determining the save destination information which is associated with the user information indicating the login user and displaying the determined save destination information.
